(19) United States
(12) Patent Application Publication
(10) Pub. No.: US 2005/0176856 A1
(43) Pub. Date: Aug. 11, 2005

(54) Disasemble resin and the manufacturing method for thereof

(76) Inventor: Jeung-Eui Seo, Seoul (KR)

Correspondence Address: Dittavong & Carlson, 10507 Braddock Road, Suite A, Fairfax, VA, 22032, US

(21) Appl. No.: 10/509,384

(22) PCT Filed: Dec. 30, 2002
(86) PCT No.: PCT/KR02/02496

(30) Foreign Application Priority Data
Mar. 29, 2002 (KR) 10-2002-0017516

(51) Int. Cl. C08L 5/00

(52) U.S. Cl. 524/27

(57) ABSTRACT

This invention is about a method of resin manufacturing and a resin which is decomposed in a short time by several kinds of microorganisms, a decomposable resin under this invention composes with carbohydrate polymer 20-64.5 wt % which has branch structures of amylose or amylopectin; hydrophilic resin 20-40 wt % which was mixed one or more than two of polyvinylalcohol, polyacrylic acid, polyethyleneacrylic acid; lublicant 5-20 wt % and thermoplastic resin 10-30 wt % and metal soap 0.5-5 wt % as stabilizer. Effects of the resin mixed under the above ratio are that the manufacturing method is simple and the cost of manufacturing is down, therefore, the consumer can get the cheaper one, furthermore this resin can be used for ordinary purposes as well as special purposes.

### TECHNICAL FIELD

The present invention relates to a biodegradable resin composition and a producing method thereof. More particularly, the present invention relates to a biodegradable resin composition, which is produced by mixing a carbohydrate polymer containing linear amylose molecules and branched amylopectin molecules, a hydrophilic polymer selected from polyvinyl alcohol, polyacrylic acid, polyethylene acrylic acid and a mixture thereof, a lubricant, a thermoplastic resin, and a stabilizer, at a suitable ratio, and extruding the mixture, and which is decomposed by microorganisms in a short time.

### BACKGROUND ART

General-purpose resins are widely used for the production of wrapping films, vinyl envelopes, and PET bottles, etc. However, the resins, which are used in such applications, are not decomposed by microorganisms after they were wasted. Thus, when buried in soil, they remain intact to waste soil quality and to inhibit the growth of plants. For this reason, the disposal of such resins becomes a serious social problem. In the world many countries, there were attempts to develop biodegradable resins with the investment of much effort, time and cost. As a result, several kinds of biodegradable resins were developed.

However, the developed degradable resins have disadvantages in that they are produced by complicated processes and formed of a large number of components, such that they have increased production costs. In addition, they cannot be used for general purposes due to their insufficient physical properties and are used only for special purposes, such as surgical sutures.

Recently, polylactic acid resins made from plants were developed. However, they are produced through the fermentation, reaction and polymerization of carbohydrate, such as starch, and their production requires larger energy than the production of polyethylene so that they are generally produced by the indirect use of fossil fuel. The polylactic acid resins produced by this method are advantageously eco-friendly but disadvantageously have increased production costs.

Moreover, Japanese patent laid-open publication Nos. 2001-026667 and 2002-020536 disclose a method for the production of biodegradable resins. In these publications, starch as a natural polymer substance, hydrophilic resin, thermoplastic resin, polyethylene glycol as a softening agent, and fat as a processability improver, are uniformly mixed with stirring, to which glycerin as a coupling agent and water are then added and uniformly mixed with stirring. The resulting mixture is formed into chips by a twin-screw extruder. On the other hand, the resin composition of the present invention contains polyethylene wax as a lubricant, and metal soap as a stabilizer, and thus has a difference in composition from the resins disclosed in the above Japanese publications.

Furthermore, the resin compositions disclosed in the above Japanese publications contain less than 8% of starch unlike the present invention, and also contains water such that their residual time inside the extruder to occur their carbonization. And they become thin dough at an inlet of the extruder and thus are dispersed, so that they are difficult to be drawn into an elongate shape and thus stuck to the inlet, thereby reducing productivity. In addition, the mixing and stirring of the respective substances for forming the resin chips are repeated two times or more to increase production costs such that a uniform mixture cannot be obtained. The non-uniform mixing of the components leads to a reduction in smoothness upon vinyl injection.

Particularly, the resin chips contain large amounts of water and thus are hardly formed into a given shape upon vinyl injection due to generated bubbles. Furthermore, the resin compositions contain glycols, such as polyethylene glycol, as a softening agent, and thus easily absorb atmospheric moisture to cause a storage problem.

Meanwhile, fat contained in the prior resin compositions is insoluble in water, has an offensive smell or taste, and is hardened at room temperature. Accordingly, upon binding with soil, the prior resin compositions have reduced porosity and thus insufficient drainage and aeration properties. On the other hand, the resin composition of the present invention shows an increased porosity due to the dispersion and separation of resin granules bound to starch. The resin compositions disclosed in the above Japanese publications comprise many kinds of components as compared to the present invention, and thus have increased production costs.

Meanwhile, Korean patent No. 0174649 discloses a biodegradable resin composition comprising starch, aliphatic co-polyester, ethylene vinyl alcohol, a plasticizer and a lubricant, in which the plasticizer is selected from water, glycerin, ethylene glycol, 4-butanediol and a combination thereof, and the lubricant is selected from triglycerol, monostearate, triglycerol distearate, triglycerol tristearate, and a combination thereof.

Moreover, Korean patent No. 0100421 discloses a biodegradable resin composition comprising starch, aliphatic co-polyester, polyvinyl alcohol, and additives, in which the additives are selected from monomethyl phosphate, trimethyl phosphate, tributyl phosphate, phosphorous acid and a combination thereof.

Korean patent No. 0332163 discloses a first biodegradable resin composition comprising an aliphatic polyester and one or more component selected from starch, water, ethylene glycol, propylene glycol, polyethylene glycol, sorbitol, glycerin, and polyvinyl alcohol, and a second biodegradable resin composition comprising aliphatic polyester and one or more components selected from starch, ethylene-acrylic acid copolymer, ethylene-methacrylic acid copolymer, acrylic acid resin, methacrylic acid resin, and vinylalcohol resin.

All the resin compositions disclosed in the Korean patents as described above contain starch and aliphatic polyester. The use of water in Korean patent No. 0174649 and the first case of Korean patent No. 0332163 causes a disadvantage as in the case of the Japanese publications as described above. Furthermore, the plasticizer used in Korean patent No. 0174649 and the ethylene and glycerin used to gelatinize starch in Korean patent No. 0332163 cause disadvantages as in the case of the Japanese publications as described above. In addition, the phosphate-based resin composition of Korean patent No. 0100421 is combined with atmospheric nitrogen upon incineration to act as a main factor of acid rain.

### DISCLOSURE OF INVENTION

Accordingly, the present invention has been made to solve the above-mentioned problems occurring in the prior art, and an object of the present invention is to provide a biodegradable resin composition and a method for producing the same, which has a simple composition and is produced by a simple process, thereby reducing production costs, and also are decomposed in a short time after wasted, such that it has no harmful effects on the natural environment.

To achieve the above object, in one aspect, the present invention provides a biodegradable resin composition, which comprises 20-64.5 wt % of a carbohydrate polymer containing linear amylose molecules and branched amylopectin molecules; 20-40 wt % of a hydrophilic resin selected from polyvinyl alcohol, polyacrylic acid, polyethylene acrylic acid, and a mixture thereof; 5-20 wt % of a lubricant; 10-30 wt % of a thermoplastic resin; and 0.5-5 wt % of metal soap as a stabilizer.

In another aspect, the present invention provides a method for producing a biodegradable resin composition, which comprises the steps of: introducing 20-64.5 wt % of a carbohydrate polymer containing linear amylose molecules and branched amylopectin molecules, 20-40 wt % of a hydrophilic resin selected from polyvinyl alcohol, polyacrylic acid, polyethylene co-acrylic acid, and a mixture thereof, 5-20 wt % of a lubricant, 10-30 wt % of a thermoplastic resin, and 0.5-5 wt % of metal soap as a stabilizer, into a mixer; stirring the introduced components while heating them to a temperature where they can be melted; extruding the stirred mixture through an extruder; cooling the extrudate in water; and cutting the cooled extrudate into a predetermined size with a cutter.

In the producing method of the present invention, the carbohydrate polymer has a water content lower than 8%, and the cooled material is cut into granules.

### BEST MODE FOR CARRYING OUT THE INVENTION

Hereinafter, the biodegradable resin composition according to the present invention and the producing method thereof will be described in detail.

The carbohydrate polymer is starch, such as corn starch, fernbrake starch, arrowroot starch, potato starch, wheat starch, barley starch, rice starch, cassava starch, sago starch, tapioca starch, bean starch, lotus root starch, water chestnut starch, or sweet potato starch. And the starches as described above can be obtained by separation from natural polymers and are non-modified starches.

The starches contained in the biodegradable resin composition according to the present invention are low molecular weight polysaccharides of plants, i.e., natural polymer polysaccharides, such as potato, sweet potato, rice, barley, corn and tapioca starches. In addition, there can be used chemical starches, such as decomposed starches, alpha-starches, starch derivatives, differentiated starches, physically treated starches, and a mixture thereof.

The decomposed starches include enzyme-modified starches, oxidized starches, acid-treated starches, and dextrin. The starch derivatives include starch esters and starch ethers. The starch esters include starch phosphate, starch acetate, starch adipate, starch maleate, starch phthalate, and starch xanthate, and the starch ethers include carboxymethyl starch, hydroxyalkyl starch, epichlorohydrin starch, aryl starch, positive starch and polymer-grafted starch.

Furthermore, the differentiated starches include amylose starch and amylopectin starch, and the physically treated starches include radiation-treated starch and high frequency-treated starch.

The biodegradable resin composition according to present invention contains the starch at the amount 20-64.5 wt %. If the starch content is below 20 wt %, the resulting resin composition will require an excessively long time for its decomposition and thus have a harmful effect on the natural environment. If the starch content is above 64.5 wt %, the resulting resin composition will advantageously show increased biodegradability but disadvantageously have insufficient formability since the content of other components is reduced.

The hydrophilic resin contained in the resin composition according to the present invention has hydroxy and carboxyl groups. Examples of this hydrophilic resin include polyvinyl alcohol (PVA), polyacrylic acid (PAA), polyethylene acrylic acid (PEA), and a mixture thereof. This hydrophilic resin is contained in the inventive composition at the amount of 20-40 wt %.

If the hydrophilic resin content is below 20 wt %, the resulting resin composition will have insufficient hydrophilicity, and if the hydrophilic resin content is above 40 wt %, the resulting resin composition will advantageously have increased hydrophilicity but disadvantageously show insufficient degradability and formability since the content of other components is reduced.

Furthermore, examples of the thermoplastic resin, which can be used in the present invention, include polyolefin, polystyrene, polyacrylonitrile, polyacrylate, polymethacrylate, polyacetal, polyacrylethyl, thermoplastic polyamide, polyethylene, polypropylene, polyisobutylene, polyvinyl chloride, polyvinyl acetate, polyamide, polyurethane, polycarbonate, polyethylene terephthalate, alkylene/vinyl ester copolymer, ABS copolymer, ethylene/acrylonitrile copolymer, amide ethyl/amide ester block copolymer, ethylene/vinyl acetate copolymer, ethylene/acrylic acid copolymer, ethylene/ethyl acrylate copolymer, and ethylene/methacrylate copolymer.

Among the hydrophilic resins, the polyolefin resin has excellent formability and is preferably used for the melt forming of a complex shape.

Moreover, the lubricant is made of polyethylene wax, etc. and acts to accelerate the uniform mixing between the carbohydrate polymer, the hydrophilic polymer and the thermoplastic resin. In addition, the stabilizer is made of metal soap and acts to prevent the physical properties of the polymers from being changed at the mixing condition of high temperature.

Hereinafter, the method for producing the biodegradable resin composition of the present invention using the components as described above will now be described in detail.

Step 1:

20-64.5 wt % of a carbohydrate polymer containing linear amylose molecules and branched amylopectin molecules; 20-40 wt % of a hydrophilic resin selected from polyvinyl alcohol, polyacrylic acid, polyethylene co-acrylic acid, and a mixture thereof; 5-20 wt % of a lubricant, such as polyethylene wax; 10-30 wt % of a thermoplastic resin, such as polyethylene; and 0.5-5 wt % of metal soap as a stabilizer, are introduced into a mixer. In this step, the carbohydrate polymer has a water content lower than 8%.

Step 2:

After the above components were introduced into the mixer in Step 1, these components are stirred with heating to their melting temperature, so that they are mixed with each other. In this case, the components are heated to 80-220° C. where they can be melted. If the heating temperature is above 200° C., the components will be thermally decomposed, and if the heating temperature is below 80° C., the components will not be melted. Also, the stirring of the components is carried out according to a rotary stirring method at a revolution of 80 rpm±20.

Step 3:

After the components were mixed with melting in Step 2, the mixture is introduced into an extruder through which the mixture is then extruded under a pressure of 20-40 kg/cm². The extrudate has a shape similar to noodles.

Step 4:

The extrudate, which was extruded in a noodle shape in Step 3, is cooled in water. Alternatively, the extrudate may be cooled by water spray or cooled air spray. Preferably, it is cooled in water.

Step 5:

The extrudate, which was cooled in Step 4, is cut into a predetermined size with a cutter and then packed. In this case, the extruded material is cut into a granule shape.

The biodegradable resin composition as described above is a material for producing the desired products, and can be formed into various films, vinyl envelopes, PET bottles, etc. by an extruder or injector for producing final products.

The biodegradable resin composition produced as described above advantageously has no harmful effect on the natural environment, particularly soil, since the carbohydrate polymer contained in the resin composition is decomposed by microorganisms, etc. in a short time after the resin composition was wasted. In addition, the resin composition may be disposed of without incineration such that the problem of air pollution caused by its incineration can be prevented.

### Industrial Applicability

As described above, the biodegradable resin composition according to the present invention is produced by a simple process and has a simple composition, so that its production costs can be reduced. Thus, it can be provided to the consumer at cheap prices and also used for general purposes in addition to special purposes.

1. A biodegradable resin composition, which comprises 20-64.5 wt % of a carbohydrate polymer containing linear amylose molecules and branched amylopectin molecules; 20-40 wt % of a hydrophilic resin selected from polyvinyl alcohol, polyacrylic acid, polyethylene acrylic acid, and a mixture thereof; 5-20 wt % of a lubricant; 10-30 wt % of a thermoplastic resin; and 0.5-5 wt % of metal soap as a stabilizer.

2. The biodegradable resin composition, wherein the carbohydrate polymer has a water content lower than 8%.

3. A method for producing a biodegradable resin composition, which comprises the steps of:
introducing 20-64.5 wt % of a carbohydrate polymer containing linear amylose molecules and branched amylopectin molecules, 20-40 wt % of a hydrophilic resin selected from polyvinyl alcohol, polyacrylic acid, polyethylene acrylic acid, and a mixture thereof, 5-20 wt % of a lubricant, 10-30 wt % of a thermoplastic resin, and 0.5-5 wt % of metal soap as a stabilizer, into a mixer;
stirring the introduced components while heating them to a temperature where they can be melted;
extruding the stirred mixture through an extruder;
cooling the extrudate in water; and
cutting the cooled extrudate into a predetermined size with a cutter.

4. The method of claim 3, wherein the carbohydrate polymer has a water content lower than 8%.

5. The method of claim 3, wherein the extrudate is cut into a granule shape.
